(19) United States
(12) Patent Application Publication
(10) Pub. No.: US 2026/0349107 A1
(43) Pub. Date: Nov. 5, 2026

(54) DETERMINING FLOOD DEPTH OF AN AREA OBJECT

(71) Applicant: ICEYE OY, Espoo (FI)

(72) Inventors: Qiaoping Zhang, Espoo (FI); Michael Wollersheim, Espoo (FI); Arnt Luthardt, Espoo (FI)

(21) Appl. No.: 19/124,504

(22) PCT Filed: Sep. 11, 2023
(86) PCT No.: PCT/EP2023/074935

§ 371 Date: Apr. 25, 2025

(30) Foreign Application Priority Data
Oct. 31, 2022 (GB) 2216056.8

(51) Int. Cl. G01S 13/90; G06T 7/50

(52) U.S. Cl. CPC G01S 13/90; G06T 7/50; G06T 2207/10044

(57) ABSTRACT

The present invention relates to computer-implemented method (100) of determining a flood depth of an area object, optionally a building structure, the method comprising: obtaining (101) a representation of the area object; creating (102) a buffer around the representation of the area object, and selecting a plurality of sampling points within the buffer; determining (103), for each sampling point, a flood depth value based on a flood model and elevation information at a geospatial location of the sampling point; and determining (104) the flood depth of the area object based on the flood depth values of the plurality of sampling points.

The present application relates to flood depth determination. In particular, the present application relates to determining a flood depth of an area object, such as a building structure.

### BACKGROUND

Natural disasters, such as a flood, have potential to cause significant loss of life or property damage. In this type of large-scale event, it can be difficult to know the extent and severity of the damage caused by the flood, especially during the flood when the situation can be highly dynamic, and also immediately after the event when infrastructure and communication systems may have been destroyed. Obtaining spatially-explicit estimation of flood depth is challenging.

Information on a flood depth is critical for first responders, recovery efforts and resiliency planning. Further, for damage assessment, accurate information on the flood depth at building level is critical to evaluate water-caused damage to an insured property during the flood. Normally, to determine if during a flood, for example due to a heavy rain or torrential rain due to typhoon, a flood depth of a building structure is equal to or greater than a reference flood depth, a large number of investigators must quickly visit the site to conduct measurements to confirm the extent of the flood.

In view of the drawbacks of the prior art, a need for remote-sensing-based flood mapping exists. In particular, a need exists to determine a flood depth of an area object with high accuracy. The embodiments described below are not limited to implementations which solve any or all of the disadvantages of the known approaches described above.

### SUMMARY

This Summary is provided to introduce a selection of concepts in a simplified form that are further described below in the Detailed Description. This Summary is not intended to identify key features or essential features of the claimed subject matter, nor is it intended to be used to determine the scope of the claimed subject matter.

Some of the methods described in the following are concerned with determining a flood depth of an area object.

In a first aspect, the present invention provides a computer-implemented method of determining a flood depth of an area object, optionally a building structure, the method comprising: obtaining a representation of the area object; creating a buffer around the representation of the area object, and selecting a plurality of sampling points within the buffer; determining, for each sampling point, a flood depth value based on a flood model and elevation information at a geospatial location of the sampling point; and determining the flood depth of the area object based on the flood depth values of the plurality of sampling points.

The representation of the area object can be a building footprint including a representation of a building's location, shape, dimensions, and area, optionally further including address, geospatial location, and/or attribute describing building's general purpose.

Obtaining the representation of the area object may include: receiving a customer location identifying the location of a building; and retrieving a building footprint based on the location from one or more input building footprint data source(s).

Determining a geospatial location of each sampling point can be achieved by matching the representation of the area object and/or the buffer with a set of geospatial data.

A visual representation of the area object can be a polygon and the buffer may resembles the shape of the polygon.

Selecting the plurality of sampling points within the buffer may include selecting the plurality of sampling points along the buffer.

Creating the buffer can include determining line and/or point features of the visual representation of the area object and buffering around the line and/or point features jointly such that buffer encompasses a perimeter of the representation of the area object.

A buffer distance may be approximately zero. The buffer may be a ring buffer. A buffer distance may be positive, preferably 0.5 m or more, and/or wherein the buffer distance may be fixed, preferably at 2 m or more, more preferably at 2.5 m.

Selecting a plurality of sampling points may include sampling along the buffer. A nominal spacing between two adjacent sampling points may be at least 0.5 m, preferably between 1 m and 5 m.

Selecting the plurality of sampling points further may include selecting sampling points at vertices of the buffer.

The flood depth of the area object may correspond to a percentile of the flood depth values of the plurality of sampling points, preferably the 90^{th} percentile value.

The method may further comprise: receiving a request to determine the flood depth at a customer location; and obtaining a representation of the area object corresponding to the customer location by assigning a building footprint to the customer location.

The flood model can be determined using image data, optionally including synthetic aperture radar ‘SAR’ data and/or optical image data obtained by a satellite, and/or ground truth data.

Elevation information at a geospatial location of each sampling point can be obtained from an elevation model such as digital terrain map (DTM) and/or a digital elevation model (DEM).

A sampling density of the sampling points may be selected based on one or more of a resolution of the elevation model, a distance to a water body, and size of the area object.

Determining the flood depth value can include determining a water height surface corresponding to a flooding peak and determining a difference between the water height surface and the elevation information the geospatial location of each sampling point.

Selecting the plurality of sampling points may further include to exclude sampling points with a geospatial location in or in close proximity to a water body, optionally a water channel. A water body can be a lake, river, water channel or stream or any combination.

Water bodies can be identified from a DTM or DEM. Such water bodies are permanent or pre-existing water bodies that were existing before the flooding started. The water bodies can be described as a permanent or pre-existing water body. Water masking may be applied to the flood model to take account of one or more water bodies.

In a second aspect, the present invention provides a computing system comprising one or more processors and memory, wherein the one or more processors are configured to implement the method according to the first aspect.

In a third aspect, the present invention provides a computer readable medium comprising instructions which when implemented on one or more processors in a computing system cause the system to implement the method according to the first aspect.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 is a flow chart illustrating a method of determining a flood depth of an area object;

FIG. 2 is a schematic diagram showing a method of flood monitoring;

FIG. 3 is a schematic diagram of a buffer created around a representation of an area object and a plurality of selected sampling points;

FIG. 4 is an optical image of a residential area including a buffer created based on a building footprint of a building structure;

FIG. 5 is a flood depth map of the residential area shown in FIG. 4 at a time of a flooding peak with the buffer created based on the building footprint of the building structure;

FIG. 6 is a diagram showing determined flood depth values for a plurality of sampling points within the buffer, determined flood depth for the building structure according to the method as described with respect to FIG. 1, as well as ground truth;

FIG. 7 shows four different examples of a buffer created around a representation of an area object, wherein FIG. 7a) shows a rectangular buffer with a fixed positive buffer distance of 2.5 m, FIG. 7b) shows a circle ring buffer with a maximum positive and negative buffer distance of 2.5 m, FIG. 7c) shows a rectangular buffer with a fixed buffer distance of zero, and FIG. 7d) shows a rectangular buffer with a maximum buffer distance of zero, wherein the buffer includes the interior of the representation;

FIG. 8 shows an optical image of a city with a plurality of customer locations that are matched or not matched to corresponding building footprints;

FIG. 9 is a table including a statistical evaluation of the results of determining a flood depth using different buffers and different statistical approaches;

FIG. 10 shows a plurality of distributions of flood depth values corresponding to the results shown in FIG. 9;

FIG. 11 is an optical image of another residential area including a buffer created based on a building footprint of a building structure;

FIG. 12 is a flood depth map of the residential area shown in FIG. 11 at a time of a flooding peak with the buffer created based on the building footprint of the building structure;

FIG. 13 is a diagram showing determined flood depth values for a plurality of sampling points within the buffer, determined flood depth for the building structure according to the method as described with respect to FIG. 1 as well as ground truth; and

FIG. 14 is a block diagram of an exemplary computing system based on which any of the methods described here may be implemented.

Common reference numerals are used throughout the figures to indicate similar features.

### DETAILED DESCRIPTION

Embodiments of the present invention are described below by way of example only. These examples represent the best mode of putting the invention into practice that are currently known to the Applicant although they are not the only ways in which this could be achieved.

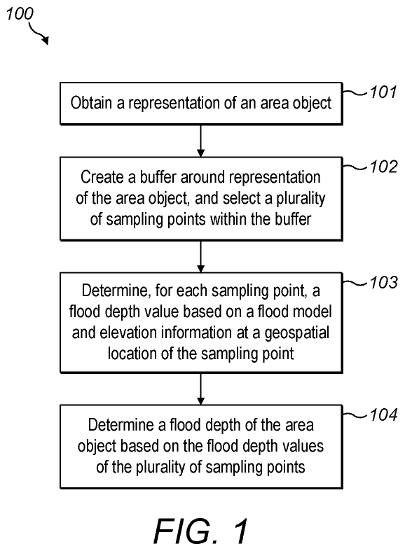

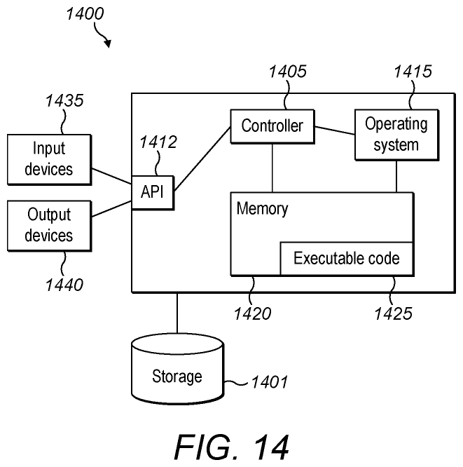

FIG. 1 is a flowchart showing a method 100 of determining a flood depth of an area object. Based on the results of the method 100, it can be determined whether an area object has been flooded, for example, by determining whether a flood depth of the area object is equal to or greater than a reference flood depth. The area object can be a building structure or part of a building structure, such as a residential, commercial, and/or industrial building. The method 100 may be a computer-implemented method. The method 100 can be performed by a computing system 1400 which is further described with reference to FIG. 14.

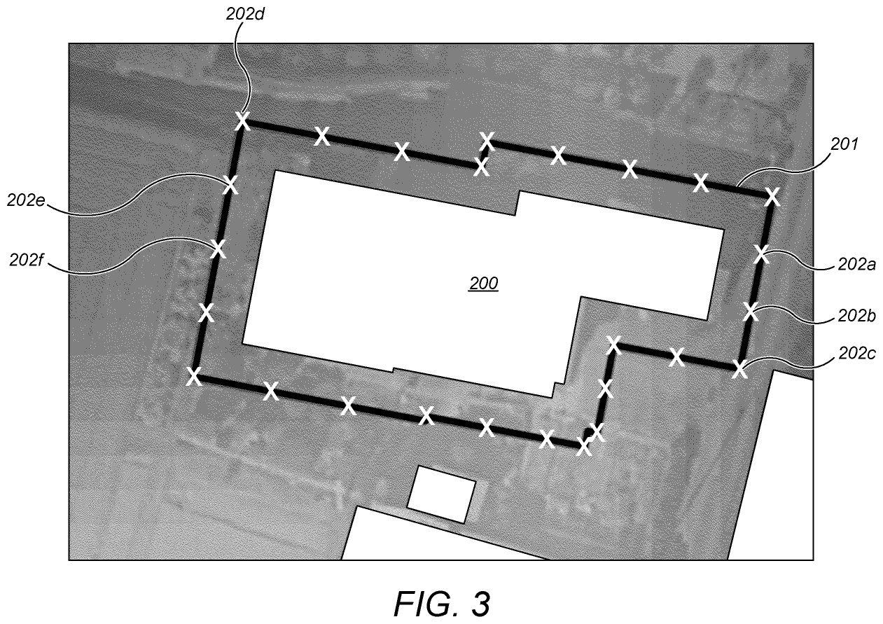

At operation 101, a representation of the area object is obtained. Where the area object is a building structure, a representation of the building structure can be a building footprint. A building footprint may be a polygon, or set of polygons, representing a specific building in the physical world. It may provide a ground-centered visual representation of a building's location, shape, dimensions, and area. Building footprints provide detailed delineations of structures or parts of properties. An example of a building footprint is further described with reference to FIG. 3.

The representation of the area object is obtained, for example, based on a customer location identifying a location of a building and/or a building structure. A building footprint can be retrieved from one or more input building footprint data sources or assigned to a customer location. Obtaining the building footprint from two or more building footprint data sources reduces the risk that a building footprint is inaccurate or outdated. Building footprint data sources can comprise generated building footprints derived from satellite imagery. Building footprint data can also be obtained from municipal geographic information systems, for example.

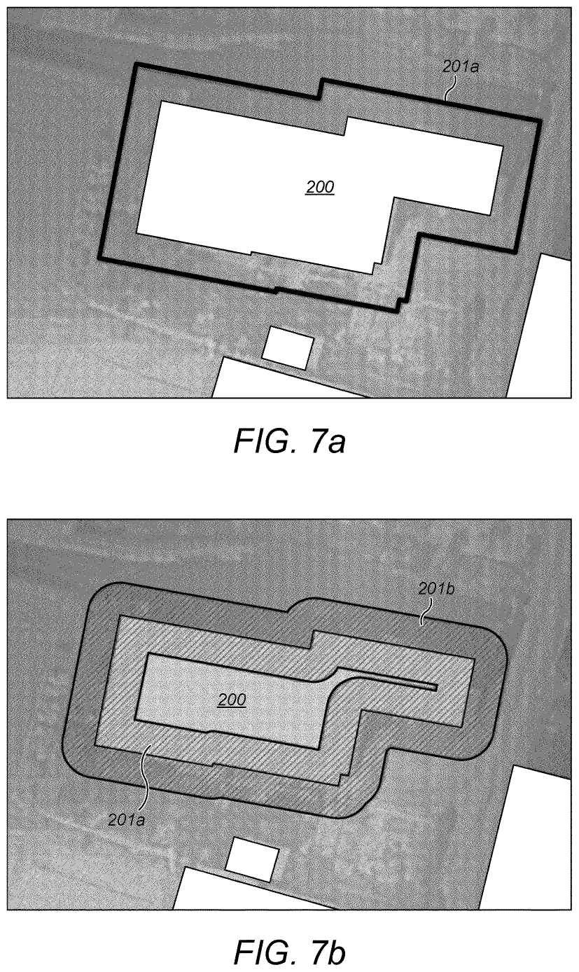

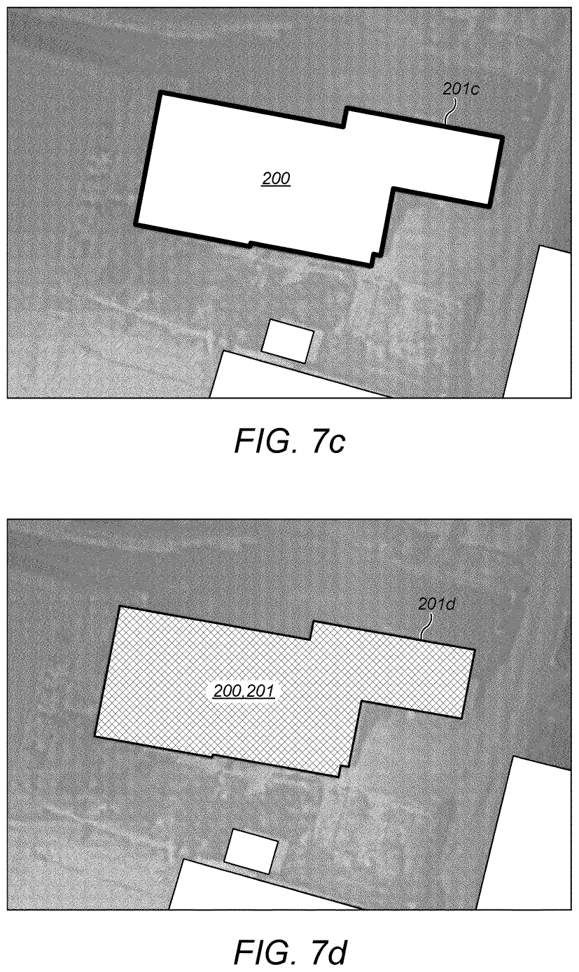

At operation 102, a buffer is created around the representation of the area object, and a plurality of sampling points are selected within the buffer. Creating a buffer is the determination of a zone around a feature containing locations that are within a specified distance (a buffer distance) of that feature, such as the buffer zone (or just buffer). Where the representation of the area object is a building footprint, line and/or point features of the (visual) representation can be determined and a buffer is created around the line and/or point features (jointly) such that the boundary of the resulting buffer encompasses a perimeter of the area object. A buffer can also be created around the whole area feature. The size of the buffer (buffer distance) can be set as constant, i.e. a fixed buffer distance. A buffer distance can be positive, zero or negative. Ring buffers can be created using multiple buffer distances. A number of different examples of buffers are described with reference to FIG. 7. Using a buffer may take account for positional uncertainties in the representation of the area object.

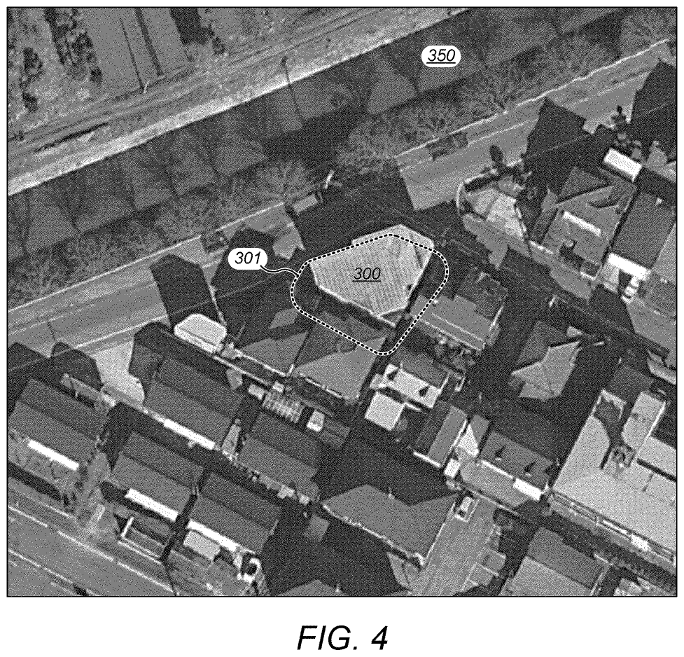

Based on the created buffer, a plurality of sampling points is selected within the buffer to ensure that the sampling points are in the vicinity of the area object. The sampling points can be selected by sampling along the buffer or an edge of the buffer. To this end, a sampling distance can be predefined to select sampling points at fixed interval(s), or a sampling density can be predefined to select sampling points by percentage. In one example, a spacing between two adjacent sampling points is at least 0.5 m or between 1 m and 5 m. Alternatively, the number of sampling points can be predefined, for example, based on the shape and/or size of the area object. Alternatively, or additionally, sampling points can be selected at vertices of the buffer. Selecting a plurality of sampling points within the buffer ensures that the sampling points are selected at geospatial locations in the vicinity of the area object, such as the building structure. Selecting the plurality of sampling points to be (equally) distributed around the area object additionally allows determination of a spatial distribution of the resulting flood depth. The latter is helpful for building structures in complex terrain (like on a slope) as is further described with reference to FIGS. 4 to 6.

At operation 103, a flood depth value is determined for each sampling point based on a flood model and elevation information at a geospatial location of the sampling point. Each sampling point corresponds to a geospatial location in the proximity of the area object, for example, a building footprint matched to a customer location. Different possibilities exist how the flood model and elevation information at the geospatial location of the sampling point can be obtained.

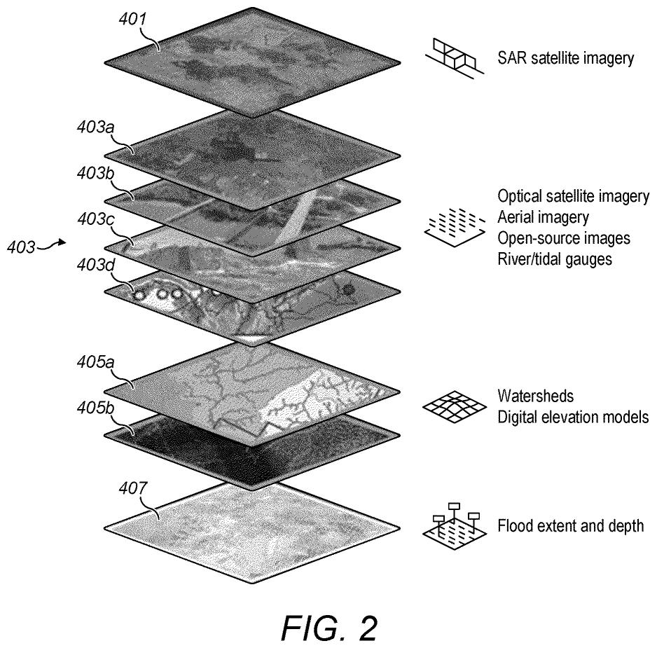

A flood model can be obtained or generated in different ways, as is further described in reference to FIG. 2. In one example, the flood model describes a water height surface corresponding to a flooding peak. Using water height surface(s) is based on the assumption that the water height surface is smooth. The water height surface can be derived from the flood model (with weather data, gauge data, terrain data, hydro network, etc.) or could be determined from corresponding earth observation images, ground measurements, etc. In one example, the flood model is generated based on multiple data sources including high-resolution SAR imagery, as is further described with reference to FIG. 2. Elevation information can be derived from an elevation model, such as a digital elevation model (DEM) or a digital terrain map (DTM). Taking into account the elevation information at a plurality of geospatial locations in the vicinity of the area object ensures that even for an area object on uneven ground the flood depth can be accurately determined.

In one example, at operation 103, flood depth values for a plurality of sampling points are determined based on a flood depth map (or flood inundation map). The flood depth map includes an area that includes the geospatial location of the area object and of the plurality of sampling points. A flood depth map is generated by combining the water height surface(s) with the corresponding elevation data, such as a DEM or a DTM. A flood depth map may represent the water height in meters above sea level. For example, according to Equation 1, a flood depth value can be calculated by subtracting a terrain elevation from the DEM from a water height surface corresponding to a flood peak at a geospatial location of the sampling point:

flood_depth_value=water_height−terrain_elevation (Equation 1)

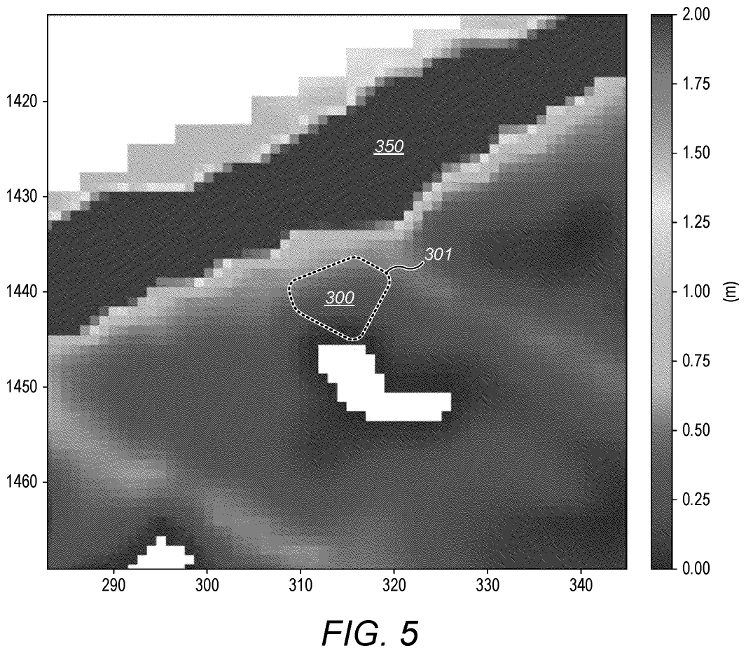

An example of a flood depth map is shown and further described with reference to FIG. 5. Generating a flood depth map of an area of interest is beneficial if a plurality of area objects in a neighbourhood are affected by the flood, and flood depths of multiple area objects need to be determined. Instead of generating a flood depth map, it is also possible to determine the flood depth values only at the geospatial location of each sampling point to save computing capacity.

At operation 104, a flood depth of the area object is determined based on the flood depth values of the plurality of sampling points. The flood depth values of the plurality of sampling points can be combined to provide one value reflecting the flood depth of the area object. For example, the flood depth can correspond to a maximum flood depth, a mean flood depth or a percentile score that is determined based on the flood depth values of the plurality of sampling points. This flood depth value at building level can be used to determine whether a building structure has been flooded.

It has been found that using a percentile instead of a mean value to calculate the flood depth based on the flood depth values provides more accurate results for the flood depth. In one example, the flood depth of the area object corresponds to the 90^{th} or 95^{th} percentile value.

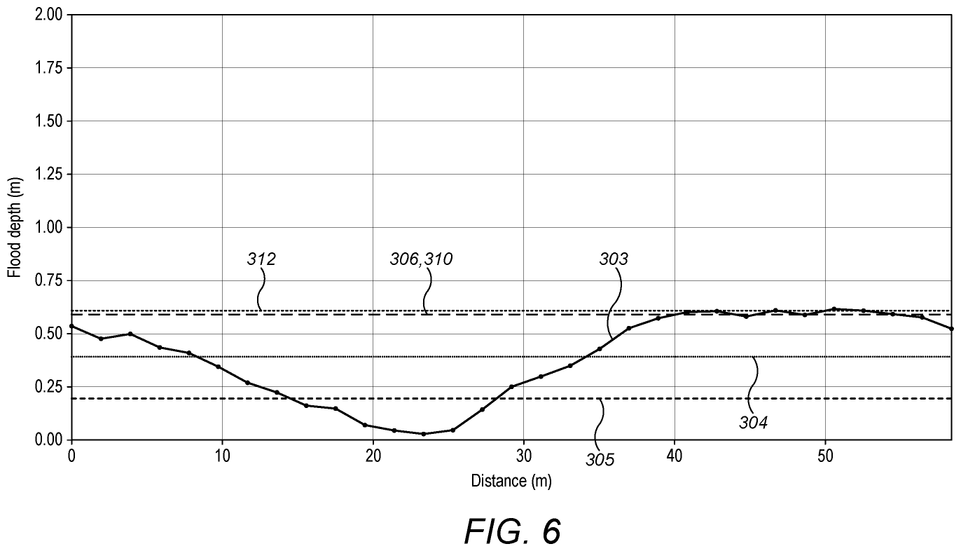

For area objects on uneven ground, it may be preferable to provide the flood depth of the area object in a format illustrating a spatial distribution of the flood depth, an example of which is shown in FIG. 6. From the flood depth values plotted against the distance along the buffer, it can be deduced whether, for example, one side of the area object has been flooded.

The method 100 as described here provides accurate results of the flood depth of a building structure at building level, as further described with reference to FIGS. 4 to 6 or 11 to 13. Determining a flood depth at building level based on only one geospatial location (for example using only one sampling point) can provide inaccurate results. For example, if a building is on a slope, part of the building could be flooded well beyond a flood threshold, whereas the rest of the building could be not flooded, leading to an erroneous result at building level indicating that the building has not been flooded.

FIG. 2 is a schematic diagram showing a method of flood observation or flood monitoring. In this example, first environmental data is collected which in this example is SAR satellite image data indicated at 401. The satellite image data may be inspected, either on the satellite or on the ground, to identify a flood event.

SAR is an active technology that sends out radar signals and receives the echoes to form the image. This is in comparison to optical satellite technologies that are passive and rely on existing light (like a camera). SAR has the advantage of being able to image during the day or night, and also through clouds and other adverse weather that is impenetrable for optical satellites. Using SAR imagery to monitor floods can provide much more frequent monitoring of flooded areas, since optical satellites cannot image at night, and often are blocked from imaging the flooded area at the most critical times by the very weather system that is causing the flooding. In one example, the flood model used at operation 103 is obtained from the SAR image data 401.

Once a flood event has been identified based on, for example, the SAR image data 401, the flood can be monitored by collecting additional data 403. Additional data may comprise additional SAR satellite imagery, optical satellite imagery 403a, aerial imagery 403b, open source images 403c such as may be obtained from social media, and river/tidal gauge information 403d shown in FIG. 2 as points on a map. The additional data 403 can be used to generate or optimize the flood model to be used at operation 103. Optical imagery 403a and aerial imagery 403b can be used to augment the SAR imagery, and open source images 403 along with data from other sensors such as river and tidal gauges 403d can be used to augment the data regarding the flood. Some of this additional data may need to be geolocated. The additional data may be used to estimate the severity of the flood at specific customer locations by determining the flood depth of an area object.

Furthermore, non-real time data may be used, examples of which are indicated in FIG. 2 as geographically indexed data such as watershed data 405a and digital elevation models (DEMs) 405b. In addition, from the non-real time data the elevation information to be used as the elevation information at operation 103 can be deduced. To create the flood model 407 representing the extent and depth of the flood, the non-real time data is combined with the additional data 403. From the flood model 407, the flood extent is visible and the flood depth can be determined.

It should be noted here that a watershed is an area which all drains into a common point. For example, the watershed of a river is all the land where rainfall on that land would end up in that particular river. Therefore, in some implementation, a watershed can be included. A DEM is usually simply a digital elevation model of the land, and whilst it may be used to determine the boundaries of a watershed it may not contain sufficient information for watersheds to be identified. Watershed information is particularly useful, for example for determining whether rainfall data is relevant or not for flooding of a particular river. If the rainfall does not “fall” within the watershed of that river, it will not contribute to the flooding. The flood model 407 can then be used to evaluate whether there is any impact of the flood on both man-made infrastructure such as buildings, and natural features such as a river or lake.

In the example of FIG. 2, the SAR data 401 and other geo-located data 403 including data from Earth based sources are combined with historical data, e.g. elevation information such as non-real time data relating to the terrain at the identified area to estimate the geographical extent of the event and the flood depth of an area object. To determine the flood depth in operation 104, the generated flood model is combined with the elevation information, such as a DEM as mentioned above or a digital terrain map (DTM), for example, to generate a flood depth map. This can be done in near real time or upon request. However, it may be necessary to determine the peak of the flood based on the monitoring. Further, determining the flood depth can comprise, for example, determining the height of damage caused by the flood in relation to the building structure.

FIG. 3 shows a representation of an area object in a flooded area. The area object is a building structure, and the representation of the area object is a building footprint 200. The building footprint 200 represents the buildings shape, dimensions and area. The building footprint 200 is a polygon. The building footprint 200 further includes the geospatial location of the building and can therefore be described as a “matched” building footprint. As can be seen in FIG. 3, the building footprint matches the underlying building structure of a customer location and is therefore depicted as an overlay on an optical image of the flooded (residential) area.

FIG. 3 shows a buffer 201 which has been created around a building footprint 200. The buffer 201 resembles the polygonal shape of the building footprint 200. The buffer 201 can be described as a perimeter buffer. The perimeter buffer is created around all sides of the building footprint, i.e. the building footprint 200 is wholly contained within the buffer 201. In this example, the buffer 201 has been created with a fixed positive buffer distance of 2.5 m.

FIG. 3 shows a plurality of sampling points 202a, 202b, 202c, 202d, 202e, 202f (i.e. sampling points 202) within the buffer 201. The sampling points 202 have been selected to be distributed along all sides of the buffer 201 including sampling points 202 at most vertices of the buffer 201. The perimeter buffers can allow possible positional uncertainties in the building footprint 200 to be accounted for.

FIG. 4 shows an optical image of a residential area including a building structure 300 for which a flood depth is determined. The optical image is superimposed with a buffer 301 specifically created for building structure 300 based on a representation (not shown) of the building structure based on a customer location. The plurality of sampling points within the buffer are not shown in FIG. 4. The small visible deviation between the buffer 301 and an outer perimeter of the upper part of the building structure 300 is due to the height of building structure 300 because building footprints usually represent a building's position at the ground level. In addition, the underlying optical image is not an orthorectified product and/or a positional uncertainty may be present in the used building footprint. The building structure 300 is located near a water channel 350.

FIG. 5 shows a flood depth map generated for the residential area shown in FIG. 4 based on a flood model and corresponding elevation information. The elevation information are obtained from a DTM. The flood depth map shows the flooded area and is superimposed with the buffer 301 to identify the location of the building structure 300 in the map. The map visualizes flood depth values in meters as indicated by the (intensity) bar next to the map. The flood depth map shows the highest flood depth values of approximately 2 m in the area of the water channel 350. The white areas in the flood depth map represent non-flooded areas. For example, areas for which negative flood depth values have been determined can be voided in the flood depth map.

FIG. 6 shows the flood depth values for a plurality of sampling points within the buffer 301 at curve 303. Flood depth profile 303 illustrates the flood depth in meters and is plotted against the distance in meters along the buffer 301 and includes flood depth values for each sampling point. A distance between the sampling points is between 1 m and 2 m, and 31 sampling points have been selected in this example. As can be seen, the profile 303 includes a minimum flood depth of approximately 3 cm (between 20 m and 30 m) and a maximum flood depth of approximately 62 cm (between 40 m and 55 m). Accordingly, the flood depth on different sides of the building structure is different. This may be due to an uneven ground. Analysing a flood depth as a profile around the building structure reduces the risk of erroneously classifying a flooded building as non-flooded when in fact at least parts of the building should be classified as flooded according to a threshold.

Further, statistical values for the flood depth determined at operation 104 and ground truth are shown in FIG. 6 for comparison. A mean flood depth of 39 cm is represented by line 304. The mean flood depth has an error (standard deviation) of +20 cm represented by line 305 (at 19 cm) and line 306 (at 59 cm), respectively. A ground truth corresponding to a flood depth of 59 cm is represented at 310. Ground truth is the information that is known to be real, provided by direct observation and measurement, usually on the ground. Ground truth is very useful but not always possible to obtain because of the time and effort required to get a person out to measure every flooded building, as well as safety issues related to accessing a flooded area. In addition, a ground truth value is sometimes only a single number and it may not always be certain what exactly the ground truth number represents. For example, the ground truth may represent where the person doing the measurement considered the maximum flood to be, or it could be where it was most convenient to measure the depth of the flood. On the ground, it can also be hard to determine the depth of the flood as it may be too difficult or impossible to find and access the exact location where the flood is deepest to make a measurement. The current method describes an improved method of determining flood depth using high-resolution satellites that can provide a more complete picture of the flood profile around a building, while at the same time replace painstaking and dangerous collection of data “on the ground”.

A statistical value for the flood depth of 61 cm corresponding to the 90^{th} percentile (and similarly a flood depth of 61 cm corresponding to the 95^{th} percentile) are represented by line 312. In this particular example, the 90^{th} and 95^{th} percentile flood depth are identical because there are 3-4 flood depth values in the set having flood depth values of 61 cm. As can be seen in FIG. 6, the 90^{th} and 95^{th} percentile value indicated at 312 are in very good agreement to the ground truth 310. The ground truth falls within the error margins of the mean flood depth but deviates from the mean flood depth by almost one standard deviation.

The above analysis further shows that having multiple flood depth values and applying statistics to determine the flood depth can provide a much more complete picture of how flooded a particular building is compared to just a single measurement

In the example shown in FIGS. 4 to 6, a water body 350 is present in proximity of the building structure. A water body can be a lake, river, water channel or stream. Water bodies can be identified from a DTM or DEM. Such water bodies are permanent or pre-existing water bodies that were existing before the flooding started. As can be seen in FIG. 5, in the area of the water body 350 high flood depth values are present. Where a water body is present in close proximity to the area object, sampling points in close proximity to the water body, i.e. within a certain distance, should be avoided. As can be seen in FIG. 5, the flood depth values in the area of the water body 350 are significantly larger than in proximity of the building structure 300. This can be achieved by, for example, selecting a sampling density based on a distance to a water body. Additionally or alternatively, sampling points with a geospatial location in or in close proximity to a water body can be excluded from the determination of the flood depth at operation 104.

FIG. 7 shows four different examples for a buffer created around the same representation 200 of an area object (i.e., input feature). The buffer 201a shown in in FIG. 7a is the same buffer 201 that is shown in FIG. 3. This buffer 201, 201a can be described as a perimeter buffer with a fixed positive buffer distance. Accordingly, a buffer polygon is created around the line features of the input feature at a specified distance. Accordingly, creating the buffer includes determining line and/or point features of the input feature and buffering around the line and/or point features jointly such that the resulting buffer 201a encompasses a perimeter of the input feature.

FIG. 7b shows a ring buffer 206 created as a combination of a fixed positive distance buffer and a fixed negative distance buffer. In this example, the distance is ±2.5 m. The hatched zone between the two perimeter buffers makes up the buffer (zone). As compared to the buffer 201a, the buffer 201b has rounded edges. The buffer 201b includes the perimeter of the representation 200 as well as an area inside and outside the representation 200.

The buffer 201c shown in FIG. 7c is another example of a perimeter buffer with a buffer distance of zero. Accordingly, the buffer 201c corresponds to the perimeter of the representation 200 of the building structure and has an identical shape as the outer perimeter of the representation 200. FIG. 7d shows another rectangular buffer 201d with a maximum buffer distance of zero. The buffer 201d includes the perimeter and the inside of the representation 200. Accordingly, the areas covered by the representation 200 and the buffer 201d are identical.

Although not shown in the examples of FIG. 7, for each buffer, a plurality of sampling points is selected by sampling along the buffer 201a-201d. In this way, the plurality of sampling pixels are disposed around the building footprint in a vicinity of the building structure.

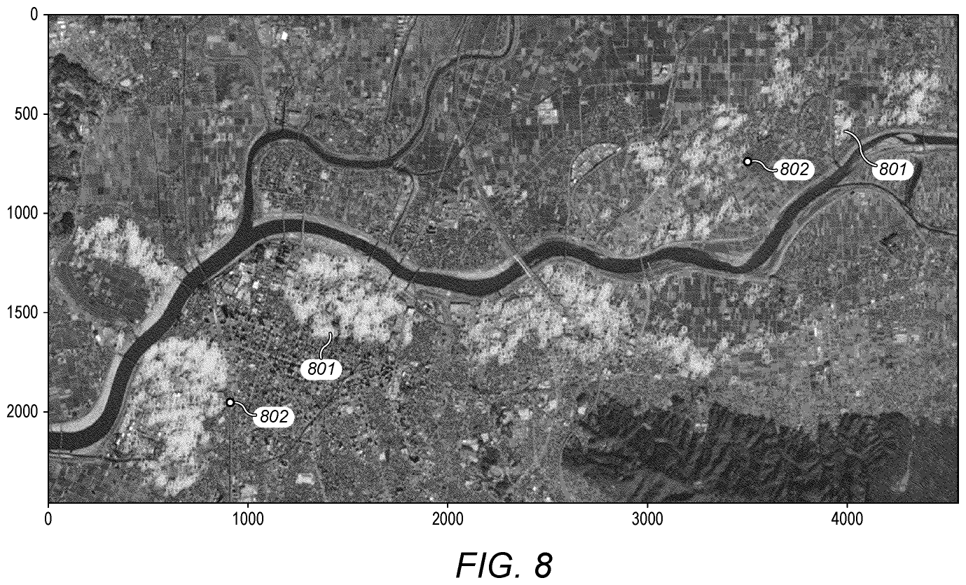

FIG. 8 is an image of a city that has been affected by a flood. In the image, a plurality of customer locations is identified. Most of the customer locations shown in FIG. 8 have successfully been matched to a building footprint via a reliable building footprint data source. Accordingly, for each of the customer locations a representation of the building structure has been obtained. To minimize a false matching rate, the matching process may include one or more input building footprint data source(s) and/or multiple iterations with more strict criteria enforced at earlier iteration. The matching criteria could be spatial relationships (within, nearby, etc.) but could also be similarity in some attributes (e.g., building names, addresses). Matched customer locations are illustrated by the brighter representations, two examples of which are indicated at 801 in FIG. 8. If no building footprint can be obtained by matching (e.g., in the case of a newly built house), a representation is obtained by creating a polygon for that specific customer location. These customer locations are illustrated by the circular representations, two examples of which are indicated at 802 in FIG. 8. In this example, the vast majority of the customer locations have been successfully matched, with only a very few unmatched locations.

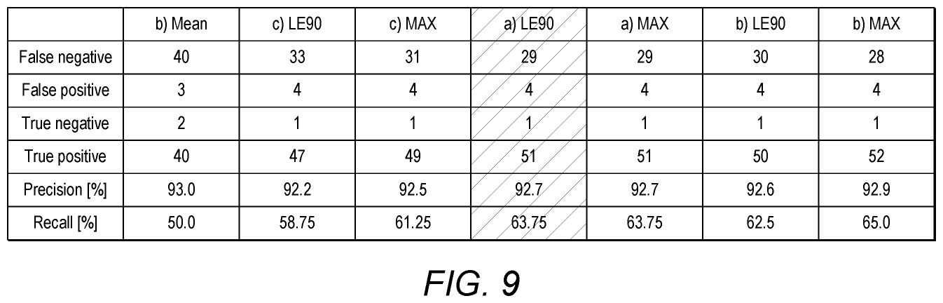

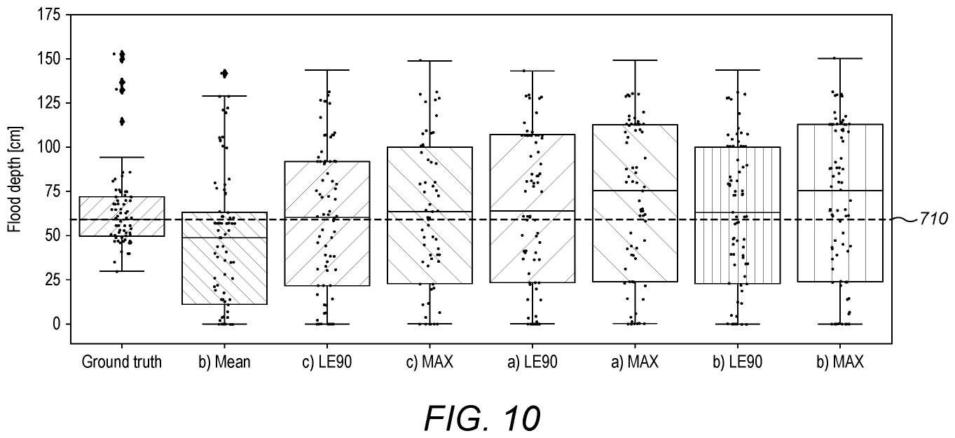

FIGS. 9 and 10 show the results of determining the flood depth according to the method 100. For evaluation, different buffers have been combined with different statistical approaches to determine the flood depth of a building structure. In an example, this has been carried out for 85 customer locations. The labels a) to c) correspond to buffers 201a-201c as shown in FIGS. 7a-7c, wherein “Mean” corresponds the mean value, “LE90” correspond to the 90^{th} percentile value and “MAX” corresponds to the maximum flood depth value. For this evaluation, the interior buffer 201d has not been included, because a DTM's vertical accuracy may be worse inside a building as it may rely on interpolation.

As shown in FIG. 9, for each combination of buffer and statistical approach, a precision of more than 90% has been achieved, wherein precision corresponds to the number of True Positives divided by the sum of True Positives and False Positive. Further, a recall of 50% or more has been achieved, recall corresponding to the number of True Positives divided by the sum of True Positives and False Positives. Therefore, it is concluded that using any one of the buffers 201a, 201b, 201c (independently of the statistical approach) to determine the flood depth ensures that a plurality of sampling points are selected in the vicinity of the building to provide accurate results for the determined flood depth at building level. By employing a buffer, the method accounts for positional uncertainties in the building footprint. Even if the building footprint should be offset by a few meters, the surrounding area is sufficiently sampled. In addition, by using a plurality of sampling points more flood depth samples are used to provide more statistically significant results.

As shown in FIG. 9, the amount of area objects that are erroneously classified as non-flooded (False Negative) when the Mean approach is used is further significantly decreased for every scenario in which the MAX or 90^{th} percentile approach are used.

Similarly, the amount of area objects that are correctly classified as flooded (True Positive) using the Mean approach is further significantly increased for every scenario in which the MAX or 90^{th} percentile approach are used. Therefore, it is concluded that using the MAX or percentile approach ensures results that are even more accurate. Where the flood depth is to be described as a single value at building level indicating whether a building has been flooded or not flooded, both the MAX and 90^{th} percentile approach provide very accurate results. From FIG. 9, it can be deduced that most accurate results, i.e. lowest False Negative rate and highest True Positive rate as shown in the highlighted column “a) LE90”, have been obtained by using buffer 201a in combination with the flood depth of the area object corresponding to the 90^{th} percentile value.

FIG. 10 shows for comparison box plots of the ground truth data and the different distributions of flood depth values that have been determined at operation 103 and the corresponding statistical analysis to determine the flood depth of the building structure at operation 104 including error bars. The first box indicates the distribution of ground truth measurements, the second box is from the main approach, and so on. The horizontal lines inside each box represent the mean value. Horizontal line 710 in FIG. 10 indicates for comparison the (average) ground truth. As can be seen, the ground truth is well within every box plot. Further, it can be seen that very accurate results have been obtained at least for c) LE90, c) MAX, a) LE90 and b) LE90. In this example, the boxplots show that the mean approach results are negatively skewed compared to the ground measurements indicating an underestimating of the flood depth, while a 90^{th} percentile based approach is more aligned with ground measurements in terms of the median values.

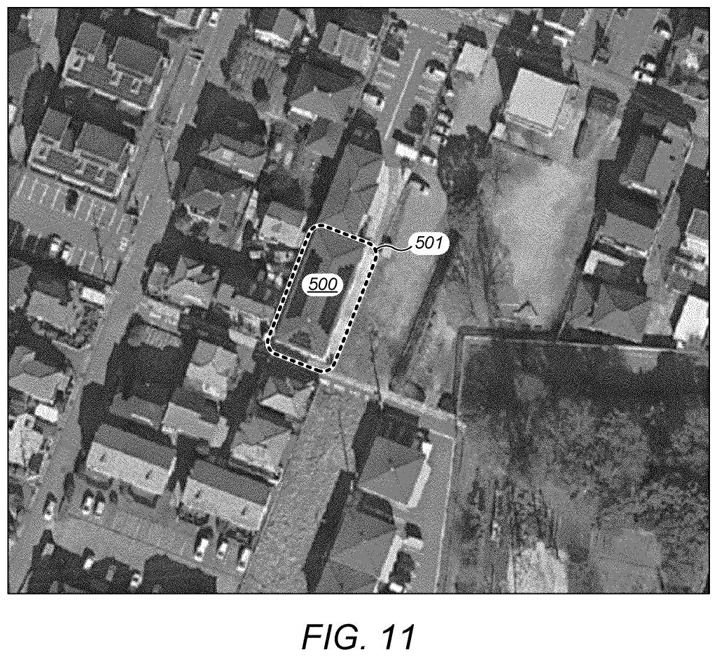

FIG. 11 shows an optical image of another residential area including a building structure 500 for which a flood depth is determined. The optical image is superimposed with a buffer 501 specifically created for the building structure 500 based on a representation (not shown) of the building structure. The plurality of sampling points selected within the buffer are not shown in FIG. 11.

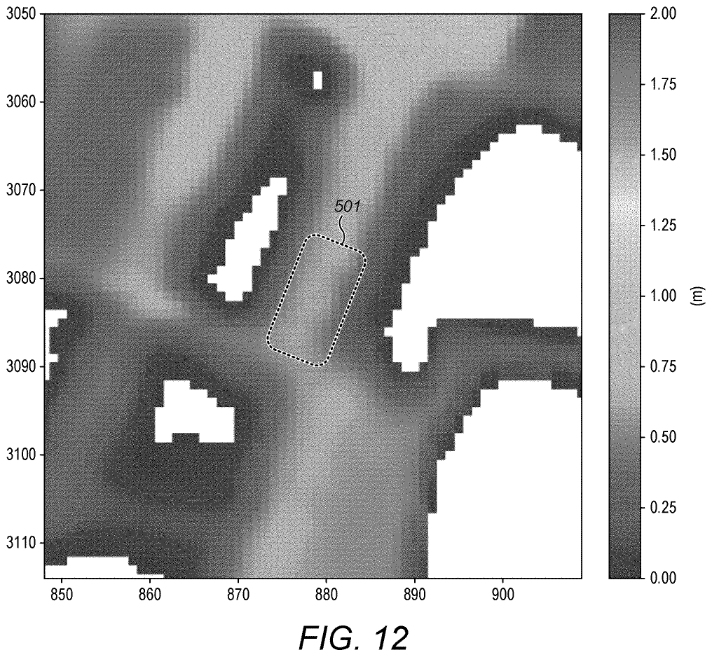

FIG. 12 shows a flood depth map generated for the residential area shown in FIG. 11 based on a flood model and corresponding elevation information. The elevation information are obtained from a DTM. The flood depth map shows the flooded area and is superimposed with the buffer 501 to identify the location of the building structure 500 in the map. The map visualizes flood depth values in meters as indicated by the (intensity) bar next to the map. The flood depth map shows the highest flood depth of 1 m to 1.25 m in the upper part of the map. The white areas in the flood depth map represent non-flooded areas.

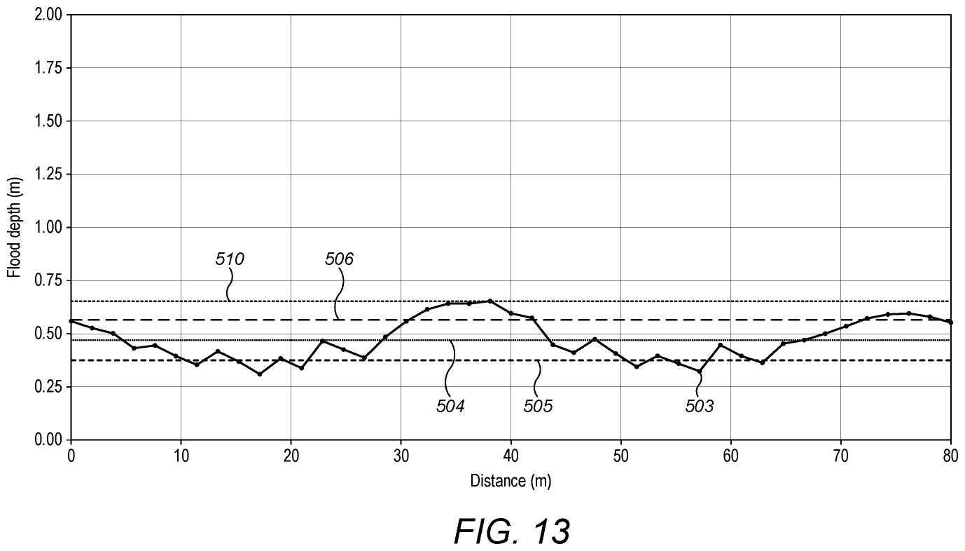

FIG. 13 shows the flood depth values for a plurality of sampling points within the buffer 501. Flood depth profile 503 shows the flood depth in meters and is plotted against the distance in meters along the buffer. In this example, the number of sampling points is 43. Accordingly, a distance between the sampling points is between 1 m and 2 m. As can be seen, the profile 503 includes significant variations of the flood depth with a maximum flood depth of approximately 65 cm. The amount of flood depth variation around the building structure 500 shows why only assigning a single flood depth corresponding to one geospatial location to each building can lead to erroneous results.

Further, statistical values for the flood depth determined at operation 104 and ground truth are shown in FIG. 13. A mean flood depth of 47 cm is represented by line 504. The mean flood depth has an error (standard deviation) of +10 cm represented by line 505 (37 cm) and line 506 (56 cm), respectively. A ground truth corresponding to a flood depth of 65 cm is represented by line 510. A statistical value for the flood depth of 59 cm corresponding to the 90^{th} percentile and a flood depth of 63 cm corresponding to the 95^{th} percentile are not shown in FIG. 13. However, it is noted that the 95^{th} percentile value is closest to the ground truth.

Reference is now made to FIG. 14 showing a block diagram of an exemplary computing system 1400 which may be used to implement any of the methods described in the foregoing, such as method 100. Computing system 1400 may comprise a single computing device or components, and functions of system 1400 may be distributed across multiple computing devices. Computing system 1400 may include one or more controllers such as controller 1405 that may be, for example, a central processing unit (CPU) processor, a chip of any suitable processor or computing or computational device, an operating system 1415, a memory 1420, storage 1401, input devices 1435 and output devices 1440.

One or more processors in one or more controllers such as controller 1405 may be configured to carry out any of the operations described above. For example, one or more processors within controller 1405 may be connected to the memory 1420 storying software or instructions that, when executed by the one or more processors, cause the one or more processors to carry out the operations. Controller 1405 or a central processing unit within controller 1405 may be configured, for example, using instructions stored in memory 1420, to perform the operations shown in FIG. 1.

Operating system 1415 may be or may include any code segment designed and/or configured to perform tasks involving coordination, scheduling, arbitration, supervising, controlling or otherwise managing operation of computing system 1400, for example, scheduling execution of programs. Operating system 1415 may be a commercial operating system. Memory 1420 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short short-term memory unit, a long term memory unit, or other suitable memory units or storage units. In one embodiment, memory 1420 is a non-transitory processor-readable storage medium that stores instructions and the instructions are executed by controller 1405. Memory 1420 may be or may include a plurality of possibly different memory units.

Executable code 1425 may be any executable code, e.g., an application, a program, a process, task or script. Executable code 1425 may be executed by controller 1405 possibly under control of operating system 1415. Executable code 1425 may comprise code for selecting an offer to be served and calculating reward predictions according to some embodiments of the invention.

Storage 1401 may be or may include one or more storage components, for example, a hard disk drive, a solid-state drive, a Compact Disk (CD) drive, a CD-Recordable (CD-R) drive, a universal serial bus (USB) device or other suitable removable and/or fixed storage unit. Memory 1420 may be a non-volatile memory having the storage capacity of storage 1401. Accordingly, although shown as separate component, storage 1401 may be embedded or included in memory 1420.

Input to and output from a computing system according to some embodiments of the invention may be via an Application Programming Interface (API), such as API 1412 shown in FIG. 14. The API 1412 shown in FIG. 14 operates under the control of the controller 1405 executing instructions stored in memory 1420.

Input devices 1435 may be or may include a mouse, a keyboard, a touch screen or pad or any suitable input device. It will be recognized that any suitable number of input devices may be operatively connected to computing system 1400 as shown by block 1435.

Output devices 1440 may include one or more displays, speakers and/or any other suitable output devices. It will be recognized that any suitable number of output devices may be operatively connected to computing system 1400 as shown by block 1440.

Input devices 1435 and output devices 1440 are shown as providing input to the system 1400 via the API 1412 for the purpose of embodiments of the invention. For the performance of other functions carried out by the system 1400, input devices 1435 and output devices 1440 may provide input to or receive output from other parts of the system 1400.

Some embodiments of the invention may include s computer readable medium or an article such as a computer or processor non-transitory readable medium, or a computer or processor non-transitory storage medium, such as for example, a memory, a disk drive, or a USB flash memory, encoding, including or storing instructions, e.g., computer-executable instructions, which, when executed by a processor or controller, carry out methods disclosed herein. For example, some embodiments of the invention may comprise a storage medium such as memory 1420, computer-executable instructions such as executable code 1425 and a controller such as controller 1405.

A system according to some embodiments may include components such as, a but not limited to, a plurality of central processing units (CPU), e.g., similar to controller 1405, or any other suitable multi-purpose or specific processors or controllers, a plurality of input units, a plurality of output units, a plurality of memory units, and a plurality of storage units. An embodiment of the system may additionally include other suitable hardware components and/or software components. In some embodiments, a system may include or may be, for example, a personal computer, a desktop computer, a mobile computer, a laptop computer, a notebook computer, a terminal, a workstation, a server computer, a Personal Digital Assistant (PDA) device, a tablet computer, a network device or any other suitable computing device. Unless explicitly stated, the method embodiments described herein are not constrained to a particular order or sequence. Additionally, some of the described method embodiments or elements thereof can occur or be performed at the same point in time.

Some operations of the methods described herein may be performed by software in machine readable form e.g., in the form of a computer program comprising computer program code. Thus, some aspects of the invention provide a computer readable medium which when implemented in a computing system cause the system to perform some or all of the operations of any of the methods described herein. The computer readable medium may be in transitory or tangible (or non-transitory) form such as storage media include disks, thumb drives, memory cards etc. The software can be suitable for execution on a parallel processor or a serial processor such that method operations may be carried out in any suitable order, or simultaneously.

This application acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The embodiments described above are largely automated. In some examples, a user or operator of the system may manually instruct some or all operations of the method to be carried out.

In the described embodiments of the invention, the system may be implemented as any form of a computing and/or electronic system as noted elsewhere herein. Such a device may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

The term “computing system” is used herein to refer to any device with processing capability such that it can execute instructions. Those skilled in the art will realise that such processing capabilities may be incorporated into many different devices and therefore the term “computing system” includes PCs, servers, smart mobile telephones, personal digital assistants and many other devices.

It will be understood that the benefits and advantages described above may relate to one embodiment or may relate to several embodiments. The embodiments are not limited to those that solve any or all of the stated problems or those that have any or all of the stated benefits and advantages.

Any reference to “an” item or “piece” refers to one or more of those items unless otherwise stated. The term “comprising” is used herein to mean including the method the method operations or elements identified, but that such operations or elements do not comprise an exclusive list and a method or apparatus may contain additional operations or elements. Further, to the extent that the term “includes” is used in either the detailed description of the claims, such term is intended to be inclusive in a manner similar to the term “comprising” as “comprising” is interpreted when employed as a transitional word in a claim.

The figures illustrate exemplary methods. While the methods are shown and described as being a series of acts that are performed in a particular sequence, it is to be understood and appreciated that the methods are not limited by the order of sequence. For example, some acts/operations can occur in a different order than what is described herein. In addition, an act can occur concurrently with another act. Further, in some instances, not all acts may be required to implement a method described herein.

It will be understood that the above description of a preferred embodiment is given by way of example only and that various modifications may be made by those skilled in the art. What has been described above includes examples of one or more embodiments. It is, of course, not possible to describe every conceivable modification and alternation of the above devices or methods for purposes of describing the aforementioned aspects, but one of ordinary skill in the art can recognize that many further modifications and permutations of various aspects are possible. Accordingly, the described aspects are intended to embrace all such alternations, modifications, and variations that fall within the scope of the appended claims.

1. A computer-implemented method of determining a flood depth of an area object, optionally a building structure, the method comprising:
obtaining a representation of the area object;
creating a buffer around the representation of the area object, and selecting a plurality of sampling points within the buffer;
determining, for each sampling point, a flood depth value based on a flood model and elevation information at a geospatial location of the sampling point; and
determining the flood depth of the area object based on the flood depth values of the plurality of sampling points.

2. The method as claimed in claim 1, wherein the representation of the area object is a building footprint including a representation of a building's location, shape, dimensions, and area, optionally further including address, geospatial location, and/or attribute describing building's general purpose.

3. The method as claimed in claim 1 or 2, wherein the obtaining the representation of the area object includes:
receiving a customer location identifying the location of a building; and
retrieving a building footprint based on the location from one or more input building footprint data source(s).

4. The method as claimed in claim 1 or 2, further including:
determining a geospatial location of each sampling point by matching the representation of the area object and/or the buffer with a set of geospatial data.

5. The method as claimed in any preceding claim, wherein a visual representation of the area object is a polygon and wherein the buffer resembles the shape of the polygon.

6. The method as claimed in claim 5, wherein the selecting the plurality of sampling points within the buffer includes selecting the plurality of sampling points along the buffer.

7. The method as claimed in any preceding claim, wherein creating the buffer includes determining line and/or point features of the visual representation of the area object and buffering around the line and/or point features jointly such that buffer encompasses a perimeter of the representation of the area object.

8. The method as claimed in any preceding claim, wherein a buffer distance is approximately zero.

9. The method as claimed in any preceding claim, wherein the buffer is a ring buffer.

10. The method as claimed in any preceding claim, wherein a buffer distance is positive, preferably 0.5 m or more, and/or wherein the buffer distance is fixed, preferably at 2 m or more, more preferably at 2.5 m.

11. The method as claimed in any preceding claim, wherein selecting a plurality of sampling points includes sampling along the buffer, wherein a nominal spacing between two adjacent sampling points is at least 0.5 m, preferably between 1 m and 5 m.

12. The method as claimed in any preceding claim, wherein selecting the plurality of sampling points further includes selecting sampling points at vertices of the buffer.

13. The method as claimed in any preceding claim, wherein the flood depth of the area object corresponds to a percentile of the flood depth values of the plurality of sampling points, preferably the 90^{th} percentile value.

14. The method as claimed in any preceding claim, further comprising:
receiving a request to determine the flood depth at a customer location; and
obtaining a representation of the area object corresponding to the customer location by assigning a building footprint to the customer location.

15. The method as claimed in any preceding claim, wherein the flood model is determined using image data, optionally including synthetic aperture radar ‘SAR’ data and/or optical image data obtained by a satellite, and/or ground truth data.

16. The method as claimed in any preceding claim, wherein elevation information at the geospatial location of each sampling point is obtained from an elevation model such as digital terrain map ‘DTM’ and/or a digital elevation model ‘DEM’.

17. The method as claimed in any preceding claim, wherein a sampling density of the sampling points is selected based on one or more of a resolution of the elevation model, distance to a water body, and size of the area object.

18. The method as claimed in any preceding claim, wherein determining the flood depth value includes determining a water height surface corresponding to a flooding peak and determining a difference between the water height surface and the elevation information the geospatial location of each sampling point.

19. The method as claimed in any preceding claim, wherein selecting the plurality of sampling points further includes to exclude sampling points with a geospatial location in or in close proximity to a water body, optionally a water channel.

20. The method as claimed in any preceding claim, wherein water masking is applied to the flood model to take account of one or more water bodies.

21. A computing system comprising one or more processors and memory, wherein the one or more processors are configured to implement the method as claimed in any of claims 1 to 20.

22. A computer readable medium comprising instructions which when implemented on one or more processors in a computing system cause the system to implement the method as claimed in any of claims 1 to 20.
